(19) United States
(12) Patent Application Publication
(10) Pub. No.: US 2011/0102964 A1
(43) Pub. Date: May 5, 2011

(54) CARTRIDGE HOLDER FOR AN ELECTROSHOCK WEAPON

(76) Inventor: Ken Bass, Chandler, AZ (US)

(21) Appl. No.: 12/611,605

(22) Filed: Nov. 3, 2009

(51) Int. Cl. H01T 23/00

(52) U.S. Cl. 361/232

(57) ABSTRACT

A discharge device cartridge has bore and terminal ends, and a cartridge holder includes a cartridge receptacle having a slot sized and shaped to receive the bore end of the discharge device cartridge so that the terminal end is exposed. The cartridge holder includes a clasp so that the cartridge holder can be carried by a belt.

### BACKGROUND OF THE INVENTION

1. Field of the Invention

This invention relates generally to loading an electroshock weapon.

2. Description of the Related Art

An electroshock weapon is an incapacitating weapon used for subduing a person by administering an electric shock, which disrupts the person's muscle functions. One type of electroshock weapon is commonly referred to as a conductive energy device (CED). These types of electroshock weapons are provided by many different manufacturers, such as TASER. The electroshock weapon includes a discharge device cartridge having bore and terminal ends. The terminal end of the discharge device cartridge includes terminals which are contacted by terminals connected to a power supply of the electroshock weapon. The bore end of the discharge device cartridge includes one or more bores through which a projectile is fired. The projectiles are connected to a wire that is electrically conductive.

The projectiles are fired in response to an electrical signal being provided to the terminal end by the power supply. The electrical signal is provided to the terminal end in response to a user pulling a trigger of the electroshock weapon. The projectiles hit the person and an electric shock is provided thereto through the wire and projectiles in a well-known manner. Examples of electroshock weapons are disclosed in U.S. Pat. Nos. 6,575,073, 6,636,412, 6,999,295, 7,143,539, 7,234,262, 7,237,352, 7,314,007, 7,350,466, 7,444,939, as well as U.S. Design Pat. No. D570,948 and U.S. Patent Application No. 20060225333.

One of the problems with electroshock weapons is that it is sometimes necessary to load them in a high stress environment. For example, after projectiles are discharged from a first discharge device cartridge, it is often desirable to remove the first discharge device cartridge from the electroshock weapon and replace it with a second discharge device cartridge which has not been fired. The second discharge device cartridge is typically loaded with the electroshock weapon by hand. However, in high stress environments, the trigger of the electroshock weapon can be inadvertently pulled so that the projectiles are accidentally fired. There have been several instances in which the projectiles have been accidentally fired through the user's hand.

There are discharge device cartridge clips that can be attached to the distal end of the grip of the electroshock weapon by replacing the battery cover. However, these types of cartridge clips require that the discharge device cartridge be removed therefrom and loaded with the user's hand. However, to remove the discharge device cartridge from the cartridge clip, one must position his or her hand over the bore end of the discharge device cartridge. Positioning the user's hand over the bore end of the discharge device cartridge increases the likelihood that the projectiles will be fired through it.

Hence, it is desirable to provide a way to load an electroshock weapon with a reduced risk of injuring the user.

### BRIEF SUMMARY OF THE INVENTION

The present invention is directed to a cartridge holder, which allows an electroshock weapon to be loaded. The novel features of the invention are set forth with particularity in the appended claims. The invention will be best understood from the following description when read in conjunction with the accompanying drawings.

### BRIEF DESCRIPTION OF THE DRAWINGS

FIG. 1 is a perspective view of a cartridge holder holding a cartridge for an electroshock weapon.

FIG. 2 is a perspective view of a cartridge receptacle of the cartridge holder of FIG. 1.

FIG. 3 is a side view of the cartridge receptacle of FIG. 2.

FIG. 4 is a perspective view of a cartridge of FIG. 1.

FIG. 5 is a side view of the cartridge of FIG. 4.

FIGS. 6 and 7 are side views of an electroshock weapon in disengaged and engaged conditions, respectively, with the cartridge of FIG. 1, wherein the cartridge is being held by the cartridge receptacle of FIG. 1.

FIG. 8 is a perspective view of a person wearing the cartridge holder of FIG. 1.

FIG. 9 is a flow diagram of a method of loading an electroshock weapon.

### DETAILED DESCRIPTION OF THE INVENTION

A cartridge holder allows a user to load an electroshock weapon without handling the cartridge. In this way, the user is less likely to inadvertently discharge a projectile of the cartridge through his or her hand during loading. The cartridge holder can be carried by a belt, and the electroshock weapon can be loaded using the cartridge holder by pointing and moving a cartridge end of the electroshock weapon downwardly. The cartridge can be withdrawn from the cartridge holder by moving the cartridge end of the electroshock weapon upwardly.

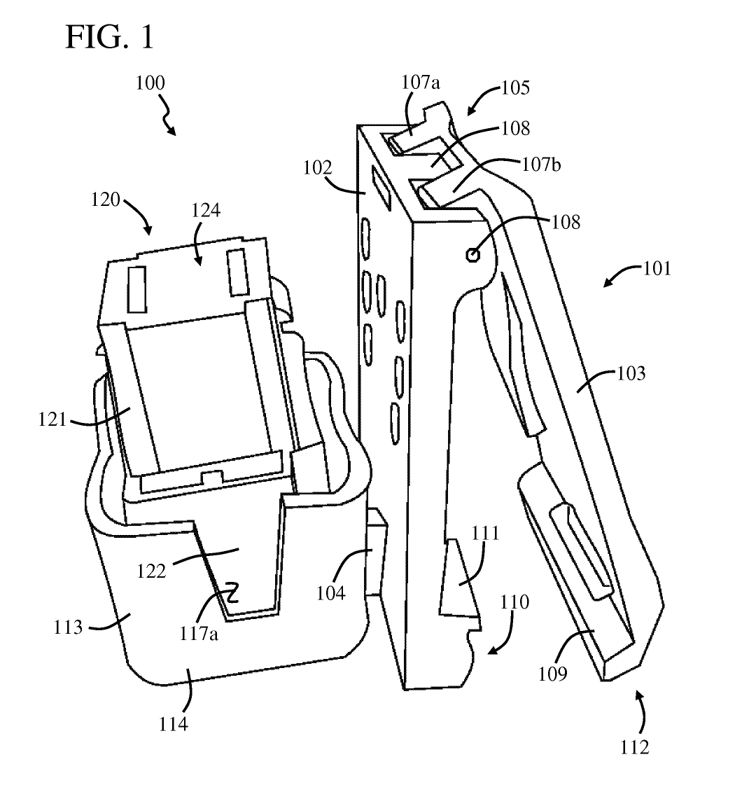

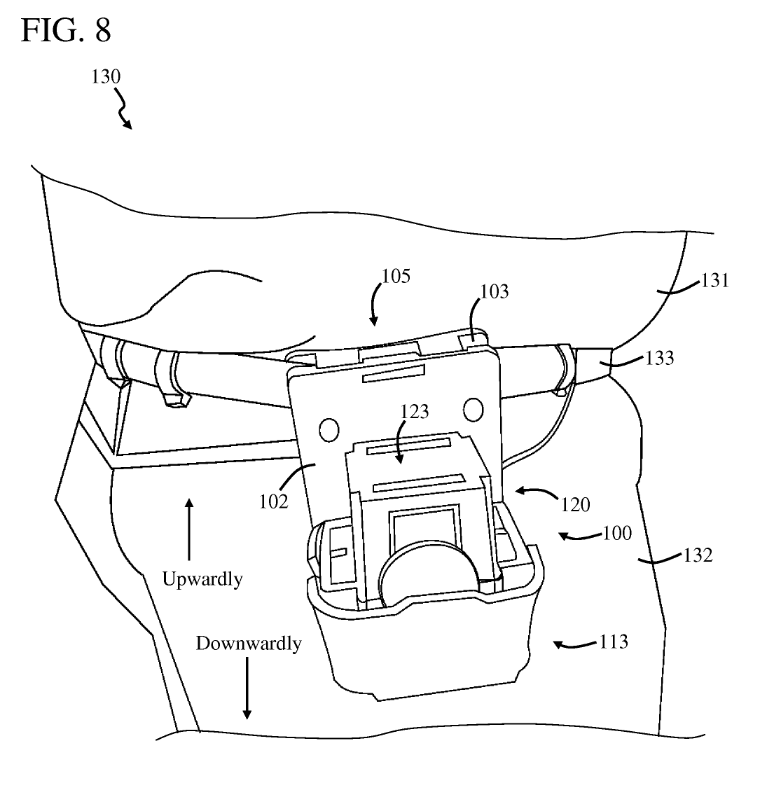

FIG. 1 is a perspective view of a cartridge holder 100 holding a cartridge 120 for an electroshock weapon (not shown). In this embodiment, cartridge holder 100 includes a clasp 101 and cartridge receptacle 113, wherein clasp 101 carries cartridge receptacle 113. Cartridge receptacle 113 is for holding cartridge 120, as will be discussed in more detail below. Clasp 101 allows cartridge holder 100 to be clasped to a belt, as will be discussed in more detail with FIG. 8.

In this embodiment, clasp 101 includes a clasp body 102 which carries cartridge receptacle 113. Clasp body 102 can carry cartridge receptacle 113 in many different ways. In this embodiment, clasp body 102 is attached to cartridge receptacle 113 with a cartridge receptacle connector 104. Cartridge receptacle connector 104 can be of many different types, such as a fastener. For example, in one embodiment, a screw extends through clasp body 102, cartridge receptacle connector 104 and cartridge receptacle 113 so that they are fastened together.

It should be noted that, in this embodiment, cartridge receptacle 113, cartridge receptacle connector 104 and clasp body 102 are separate pieces. However, in other embodiments, cartridge receptacle 113, cartridge receptacle connector 104 and/or clasp body 102 are integrated together so they are not separate pieces.

In this embodiment, clasp 101 includes a clasp arm 103 rotatably coupled with clasp body 102, so that clasp arm 103 is repeatably moveable between open and closed conditions. Clasp arm 103 is shown in the open condition in FIG. 1. Clasp 103 is generally in the closed condition when it is clasping a belt, such as in FIG. 8. In the open condition, a distal end 112 of clasp arm 103 is away from clasp body 102 and, in the closed condition, distal end 112 of clasp arm 103 is towards clasp body 102.

Clasp arm 103 and clasp body 102 can be rotatably coupled together in many different ways. In this embodiment, clasp arm 103 and clasp body 102 are rotatably coupled together by a finger joint 105. Finger joint 105 includes a tongue 108, which is carried by clasp body 102, and opposed tongues 107a and 107b, which are carried by clasp arm 103. Opposed tongues 107a and 107b are spaced apart from each other so that tongue 108 can extend therebetween. In this embodiment, finger joint 105 includes a pin 108 which extends through tongues 108, 107a and 107b. Pin 108 holds tongue 108 between opposed tongues 107a and 107b. Pin 108 allows clasp arm 103 and clasp body 102 to rotate relative to each other. In this way, clasp arm 103 and clasp body 102 are rotatably coupled together.

In this embodiment, clasp arm 103 and clasp body 102 are held together when clasp 101 is in the closed condition. Clasp arm 103 and clasp body 102 are held together when clasp 101 is in the closed condition so that clasp 101 is less likely to inadvertently unclasp from the belt, such as when running. Clasp arm 103 and clasp body 102 can be held together in many different ways. In this embodiment, clasp 101 includes a clasp groove 110 carried by clasp body 102, wherein clasp groove 110 is positioned proximate to cartridge receptacle connector 104. Clasp groove 110 extends through a clasp body protrusion 111 of clasp body 102, wherein clasp body protrusion 111 extends away from cartridge receptacle connector 104.

In this embodiment, clasp 101 includes a clasp tongue 109 carried by clasp arm 103, wherein clasp tongue 109 is positioned proximate to distal end 112 of clasp arm 103. Clasp groove 110 is sized and shaped to receive clasp tongue 109 when distal end 112 is rotated towards clasp body 102. Clasp groove 110 holds clasp tongue 109 when clasp tongue 109 is received by clasp groove 110. Clasp tongue 109 frictionally engages clasp body protrusion 111 within clasp groove 110 so that distal end 112 of clasp arm 103 and clasp body 102 are frictionally engaged together. It should be noted that clasp 101 can be held in the closed condition in many other ways, such as by using a snap and a lock.

As mentioned above, clasp 101 is repeatably moveable between open and closed conditions. In the open condition, clasp tongue 109 is away from clasp groove 110 and, in the closed condition, clasp tongue 109 is towards clasp groove 110. In the open condition, clasp tongue 109 is away from clasp body protrusion 111 and, in the closed condition, clasp tongue 109 is towards clasp body protrusion 111.

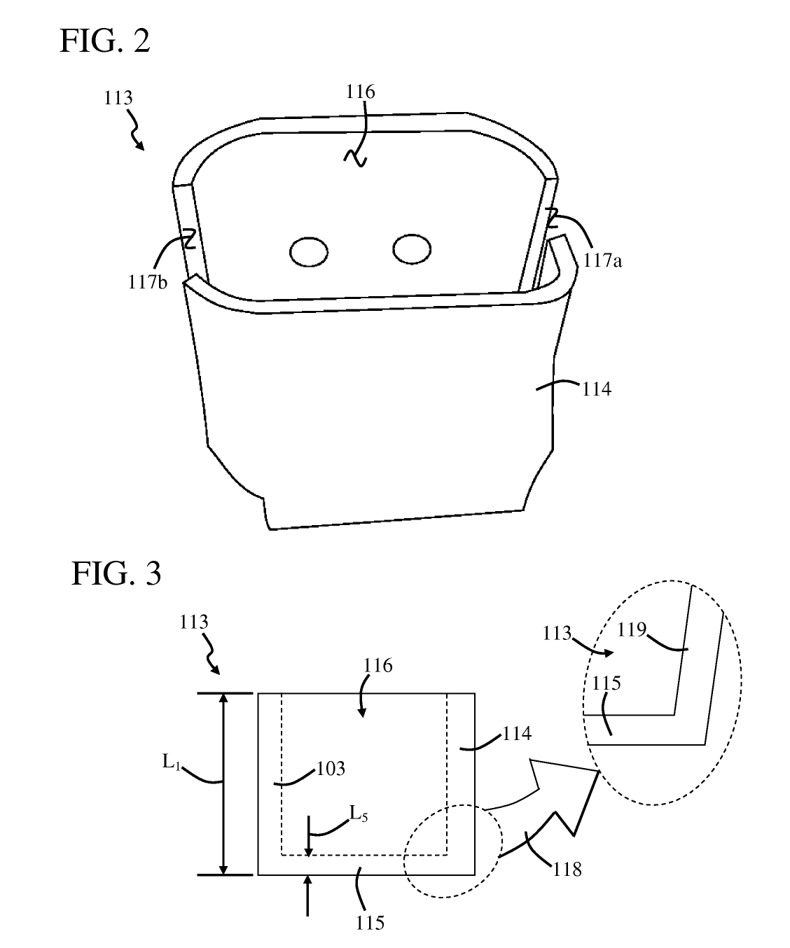

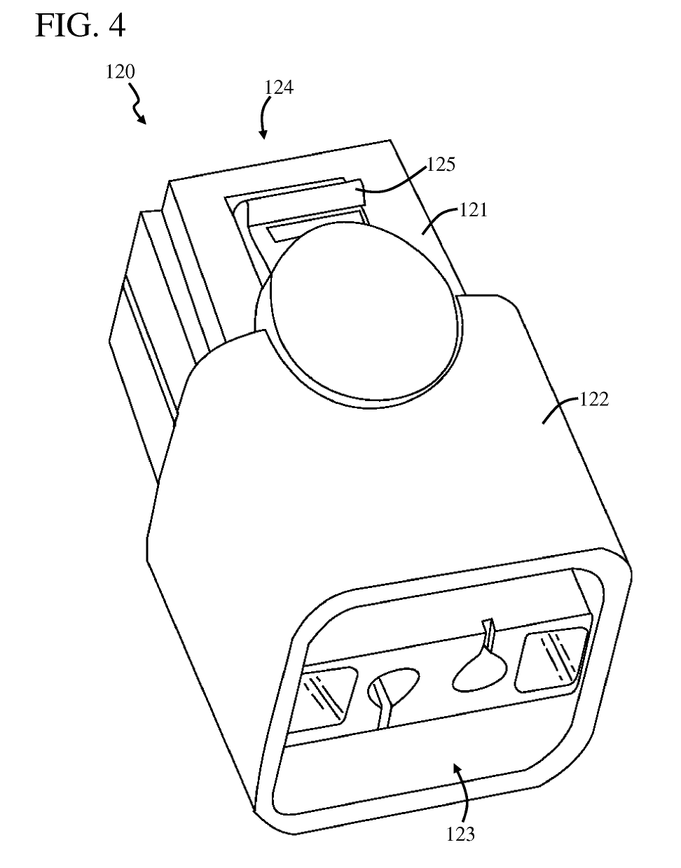

FIG. 2 is a perspective view of cartridge receptacle 113, and FIG. 3 is a side view of cartridge receptacle 113. In this embodiment, cartridge receptacle 113 includes a cartridge receptacle sidewall 114 which extends upwardly from a cartridge receptacle end wall 115 (FIG. 3). Cartridge receptacle sidewall 114 extends substantially perpendicular to cartridge receptacle end wall 115.

It should be noted that, in some embodiments, cartridge receptacle 113 includes a tapered sidewall. For example, as indicated by an indication arrow 118 in FIG. 3, cartridge receptacle 113 includes a tapered sidewall 119. Tapered sidewall 119 extends at a non-perpendicular angle away from cartridge receptacle end wall 115.

Cartridge receptacle sidewall 114 can include many different types of material. In this embodiment, and the embodiment of indication arrow 118, cartridge receptacle sidewall 114 includes a soft material. In general, the material of cartridge receptacle sidewall 114 is harder than the material of cartridge receptacle end wall 115 (FIG. 3). The material of cartridge receptacle sidewall 114 is soft so that it is flexible and resilient. The material of cartridge receptacle sidewall 114 is flexible and resilient so that is can frictionally engage cartridge 120. The material of cartridge receptacle sidewall 114 is flexible and resilient so that is can conform to the shape of cartridge 120 in response to inserting cartridge 120 into cartridge receptacle 113.

Cartridge receptacle sidewall 114 bounds a cartridge receptacle slot 116, which is opposed to cartridge receptacle end wall 115. Cartridge receptacle sidewall 114 extends between cartridge receptacle slot 116 and cartridge receptacle end wall 115. Cartridge receptacle slot 116 is sized and shaped to receive cartridge 120, as will be discussed in more detail below. As shown in FIG. 2, cartridge receptacle 113 has a dimension L₁ which is the distance between cartridge receptacle end wall 115 and the upper portion of cartridge receptacle sidewall 114.

Cartridge receptacle end wall 115 restricts the ability of a projectile fired from the electroshock weapon to move through cartridge receptacle 113. For example, in some situations, the projectile is inadvertently fired when cartridge 120 is being carried by cartridge receptacle 113. In some situations, the projectile is inadvertently fired when cartridge 120 is being carried by cartridge receptacle 113 and cartridge holder 100 is being carried by the belt, as shown in FIG. 8.

There are many different ways in which cartridge receptacle end wall 115 can restrict the ability of the projectile fired from the electroshock weapon to move. For example, in some embodiments, a dimension L₅ of cartridge receptacle end wall 115 is chosen to restrict the ability of the projectile fired by the electroshock weapon to move through cartridge receptacle end wall 115. Dimension L₅ corresponds with the thickness of cartridge receptacle end wall 115. In general, the projectile is more likely to move through cartridge receptacle end wall 115 as dimension L₅ decreases. Further, the projectile is less likely to move through cartridge receptacle end wall 115 as dimension L₅ increases.

In some embodiments, the material of cartridge receptacle end wall 115 is chosen to restrict the ability of the projectile fired by the electroshock weapon to move through cartridge receptacle end wall 115. In general, the projectile is more likely to move through cartridge receptacle end wall 115 as the hardness of the material of cartridge receptacle end wall 115 decreases. Further, the projectile is less likely to move through cartridge receptacle end wall 115 as the hardness of the material of cartridge receptacle end wall 115 increases.

In this embodiment, cartridge receptacle 113 includes finger slots 117a and 117b, which extend through cartridge receptacle sidewall 114. Finger slots 117a and 117b extend through opposed portions of cartridge receptacle sidewall 114. Finger slots 117a and 117b allow a user to grasp cartridge body 120 when cartridge 120 is received by cartridge receptacle 113. Grasping cartridge 120 through finger slots 117a and 117b facilitates the ability of the user to move cartridge 120 through cartridge receptacle slot 116. For example, it is sometimes desirable to remove one cartridge from cartridge receptacle 113 and replace it with another one.

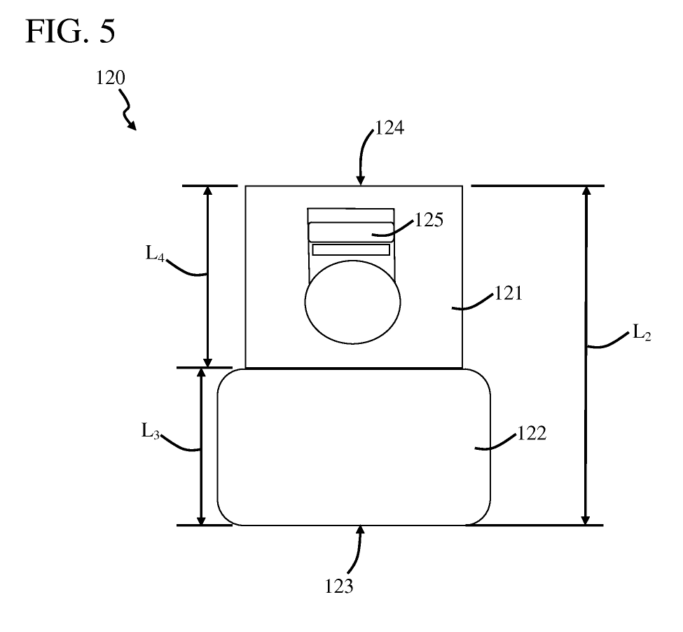

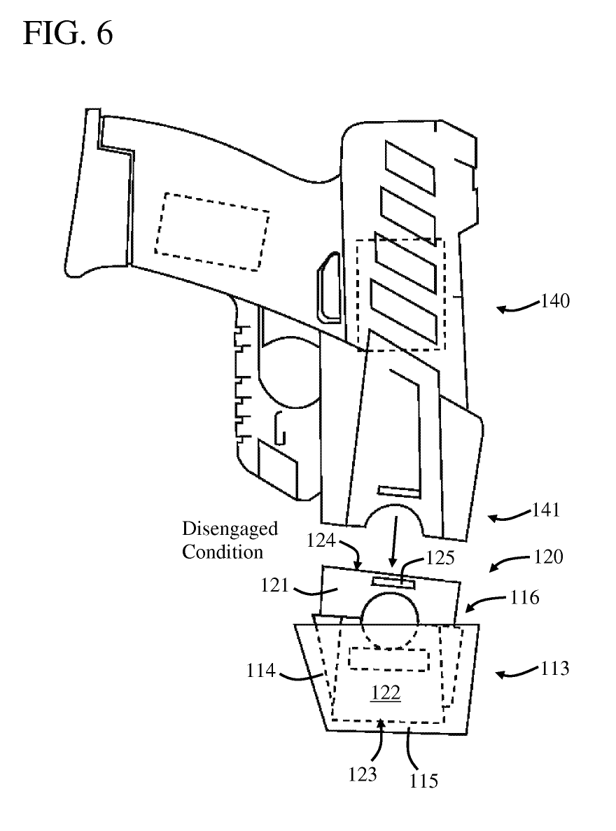

FIG. 4 is a perspective view of cartridge 120, and FIG. 5 is a side view of cartridge 120. Cartridge 120 can be of many different types, such as those disclosed in the references mentioned in the Background. In this embodiment, cartridge 120 is of the type that is used with an electroshock weapon. Cartridge 120 includes proximal cartridge body 121, and proximal cartridge body 121 includes a terminal end 124. Terminal end 124 includes terminals which are contacted by terminals connected to a power supply of the electroshock weapon. Proximal cartridge body 121 includes a cartridge clasp 101 which engages and holds cartridge 120 to the electroshock weapon in a well-known manner.

In this embodiment, cartridge 120 includes a distal cartridge body 122, and distal cartridge body 122 includes a bore end 123. Bore end 123 includes one or more bores through which the projectile moves through in response to pulling a trigger of the electroshock weapon. It should be noted that bore end 123 and terminal end 124 generally have different dimensions. In this embodiment, bore end 123 and terminal end 124 have different dimensions because bore end 123 has a larger cross-sectional area than terminal end 124. In this embodiment, distal cartridge body 122 has a length L₃ and proximal cartridge body 121 has a length L₄. Cartridge 120 has a length L₂ which is the sum of lengths L₃ and L₄.

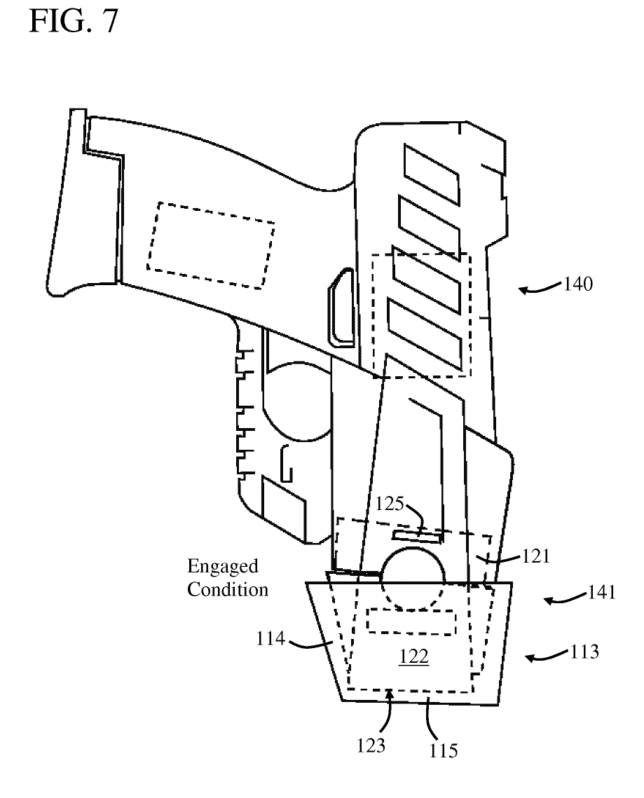

FIGS. 6 and 7 are side views of an electroshock weapon 140 in disengaged and engaged conditions, respectively, with cartridge 120, wherein cartridge 120 is held by cartridge receptacle 113 as shown in FIG. 1. It should be noted that cartridge receptacle 113 is held by clasp 101 as discussed in more detail with FIG. 1. However, clasp 101 is not shown in FIGS. 6 and 7 for simplicity.

Cartridge 120 is held by cartridge receptacle 113 so that bore end 123 faces cartridge receptacle end wall 115 when distal cartridge body 122 is received by cartridge receptacle slot 116. Further, terminal end 124 faces away from cartridge receptacle slot 116 opening when distal cartridge body 122 is received by cartridge receptacle slot 116. Terminal end 124 extends away from cartridge receptacle slot 116 when distal cartridge body 122 is received by cartridge receptacle slot 116. Terminal end 124 faces away from cartridge receptacle slot 116 when distal cartridge body 122 is received by cartridge receptacle slot 116. Terminal end 124 and bore end 123 of cartridge 120 are on opposed sides of cartridge receptacle slot 116 when cartridge 120 is received by cartridge receptacle slot 116. Terminal end 124 and bore end 123 of cartridge 120 are on opposed sides of cartridge receptacle slot 116 when distal cartridge body 122 is received by cartridge receptacle slot 116.

In the disengaged condition, cartridge end 141 of electroshock weapon 140 is away from cartridge 120. In particular, cartridge end 141 of electroshock weapon 140 is away from terminal end 124 of proximal cartridge body 121. In the engaged condition, cartridge end 141 of electroshock weapon 140 is towards cartridge 120. In particular, cartridge end 141 of electroshock weapon 140 engages terminal end 124 of proximal cartridge body 121. In the engaged condition, cartridge clasp 125 engages cartridge end 141 of electroshock weapon 140 so that cartridge 120 is held thereto.

As mentioned above, distal cartridge body 122 has a length L₃ and proximal cartridge body 121 has a length L₄. Length L₁ of cartridge receptacle 113 (FIG. 3) is chosen so that proximal cartridge body 121 extends away from cartridge receptacle slot 116 when bore end 123 is received by cartridge receptacle slot 116. Length L₁ of cartridge receptacle 113 is chosen so that proximal cartridge body 121 extends away from cartridge receptacle slot 116 so that cartridge 120 can be engaged with the electroshock weapon when bore end 123 is received by cartridge receptacle slot 116. Length L₁ of cartridge receptacle 113 is chosen so that terminal end 124 of proximal cartridge body 121 is exposed and can be engaged with the electroshock weapon when bore end 123 is received by cartridge receptacle slot 116. Length L₁ of cartridge receptacle 113 (FIG. 3) is chosen so that proximal cartridge body 121 faces away from cartridge receptacle slot 116 when bore end 123 is received by cartridge receptacle slot 116. In this way, cartridge holder 100 includes a slot sized and shaped to receive a bore end of a cartridge so that a terminal end thereof is exposed.

Length L₁ of cartridge receptacle 113 (FIG. 3) is chosen so that proximal cartridge body 121 extends away from cartridge receptacle slot 116 when distal cartridge body 122 is received by cartridge receptacle slot 116. Length L₁ of cartridge receptacle 113 is chosen so that proximal cartridge body 121 extends away from cartridge receptacle slot 116 so that cartridge 120 can be engaged with the electroshock weapon when distal cartridge body 122 is received by cartridge receptacle slot 116. Length L₁ of cartridge receptacle 113 is chosen so that terminal end 124 of proximal cartridge body 121 is exposed and can be engaged with electroshock weapon 140 when distal cartridge body 122 is received by cartridge receptacle slot 116. In this way, cartridge holder 100 includes a slot sized and shaped to receive a distal cartridge body of a cartridge so that a terminal end thereof is exposed.

FIG. 8 is a perspective view of a person 130 wearing cartridge holder 100. It should be noted that person 130 can correspond with the user mentioned above. In this embodiment, person 130 is wearing a belt 133 around his or her waist, and cartridge holder 100 is carried by belt 133. Cartridge holder 100 is carried by belt 133 by moving clasp 101 to the open condition. Clasp 101 is moved to the open condition by moving distal end 112 of clasp arm 103 away from clasp body 102. Clasp 101 is moved to the open condition by moving clasp tongue 109 away from clasp groove 110.

Belt 133 is extended between clasp body 102 and clasp arm 103, and clasp 101 is moved to the closed condition. Clasp 101 is moved to the closed condition by moving distal end 112 of clasp arm 103 from a position away from clasp body 102 to a position towards clasp body 102. Clasp 101 is moved to the closed condition by moving clasp tongue 109 towards clasp groove 110.

As mentioned above, clasp 101 is repeatably moveable between open and closed conditions. In the open condition, clasp tongue 109 is away from clasp groove 110 and, in the closed condition, clasp tongue 109 is towards clasp groove 110. Clasp tongue 109 is moved towards clasp groove 110 so that clasp groove receives clasp tongue 109. Clasp groove 110 holds clasp tongue 109 when clasp tongue 109 is received by clasp groove 110. Clasp tongue 109 frictionally engages clasp body protrusion 111 within clasp groove 110 so that clasp arm 103 and clasp body 102 are frictionally engaged together. In this way, clasp 101 holds cartridge holder 100 to belt 133. Clasp arm 103 and clasp body 102 are held together when clasp 101 is in the closed condition so that clasp 101 is less likely to inadvertently unclasp from the belt.

It should be noted that electroshock weapon 140 can be loaded with cartridge 120 of FIG. 8 in a manner as described above with FIGS. 6 and 7. It should also be noted that cartridge holder 100 is shown in FIG. 8 as being positioned at the right side of person 130. However, cartridge holder 100 can be positioned at many other locations. For example, cartridge holder 100 can be positioned at the front of person 130, if desired. The positioning of cartridge holder 100 depends on many different factors, such as the preferences of person 130. For example, person 130 may prefer cartridge holder 100 to be positioned at his or her right side or right front side when person 130 is right handed. Person 130 may prefer cartridge holder 100 to be positioned at his or her left side or left front side when person 130 is left handed.

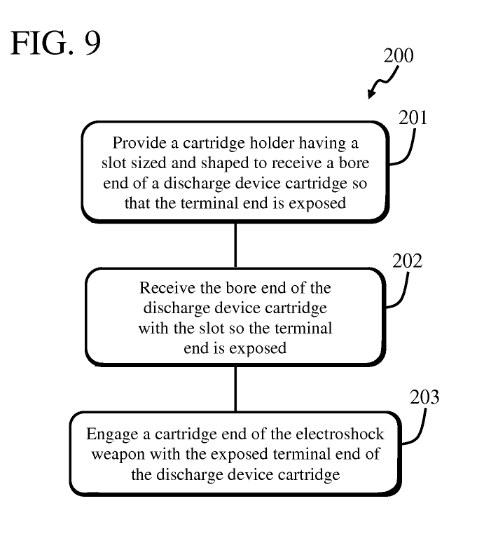

FIG. 9 is a flow diagram of a method 200 of loading an electroshock weapon. In this embodiment, method 200 includes a step 201 of providing a cartridge holder having a slot sized and shaped to receive a bore end of a discharge device cartridge so that the terminal end is exposed. It should be noted that the cartridge holder is typically provided already manufactured in step 201. However, step 201 of providing the cartridge holder can include one or more manufacturing steps, if desired. Step 201 of providing the cartridge holder can include carrying the cartridge holder with a belt. The belt generally holds the cartridge holder so the slot faces upwardly.

Method 200 includes a step 202 of receiving the bore end of the discharge device cartridge with the slot so the terminal end is exposed.

Method 200 includes a step 203 of engaging a cartridge end of the electroshock weapon with the exposed terminal end of the discharge device cartridge. Step 203 of engaging the cartridge end of the electroshock weapon with the exposed terminal end can include pointing the cartridge end of the electroshock weapon downwardly.

Method 200 can include many other steps. For example, in some embodiments, method 200 includes moving the electroshock weapon away from the cartridge holder so that discharge device cartridge is moved away from the slot. In some embodiments, method 200 includes moving the electroshock weapon away from the cartridge holder so that discharge device cartridge is moved through the slot.

The embodiments of the invention described herein are exemplary and numerous modifications, variations and rearrangements can be readily envisioned to achieve substantially equivalent results, all of which are intended to be embraced within the spirit and scope of the invention.

1. Apparatus, comprising:
a discharge device cartridge having bore and terminal ends; and
a cartridge holder having a slot sized and shaped to receive the bore end of the discharge device cartridge so that the terminal end is exposed.

2. The apparatus of claim 1, wherein the cartridge holder includes a cartridge holder body having a cartridge holder end wall opposed to the slot.

3. The apparatus of claim 2, wherein the cartridge holder body includes a sidewall which bounds the slot, wherein the sidewall frictionally engages the cartridge holder body.

4. The apparatus of claim 3, wherein the sidewall includes a material more flexible than the material of the cartridge holder end wall.

5. The apparatus of claim 1, wherein the bore end of the discharge device cartridge faces the cartridge holder end wall when received by the slot.

6. The apparatus of claim 1, wherein the terminal end of the discharge device cartridge extends away from the slot when the discharge device cartridge is received by the slot.

7. The apparatus of claim 1, wherein the terminal end of the discharge device cartridge faces away from the slot when the discharge device cartridge is received by the slot.

8. Apparatus, comprising:
a discharge device cartridge having bore and terminal ends; and
a cartridge holder having a cartridge receptacle, wherein the cartridge receptacle includes a sidewall which bounds a slot, the slog being sized and shaped to frictionally receive the bore end of the discharge device cartridge.

9. The apparatus of claim 8, further including a belt which carries the cartridge holder.

10. The apparatus of claim 8, wherein the cartridge holder includes a clasp connected to the cartridge receptacle.

11. The apparatus of claim 10, wherein the clasp includes a clasp arm rotatably connected to a clasp body.

12. The apparatus of claim 8, wherein the cartridge includes a proximal cartridge body and distal cartridge body, the proximal cartridge body extending away from the slot when the distal cartridge body is received by the slot.

13. The apparatus of claim 12, wherein the terminal end is carried by the proximal cartridge body, the terminal end being exposed when the distal cartridge body is received by the slot.

14. The apparatus of claim 12, wherein the bore end faces the cartridge holder end wall when the distal cartridge body is received by the slot.

15. The apparatus of claim 12, wherein the terminal and bore ends of the discharge device cartridge are on opposed sides of the slot opening when the distal cartridge body is received by the slot.

16. A method of loading an electroshock weapon, comprising:
providing a cartridge holder having a slot sized and shaped to receive a bore end of a discharge device cartridge so that the terminal end is exposed;
receiving the bore end of the discharge device cartridge with the slot so the terminal end is exposed; and
engaging a cartridge end of the electroshock weapon with the exposed terminal end of the discharge device cartridge.

17. The method of claim 16, further including moving the electroshock weapon away from the cartridge holder so the discharge device cartridge is moved through the slot.

18. The method of claim 16, wherein the step of engaging the cartridge end of the electroshock weapon with the exposed terminal end includes pointing the cartridge end of the electroshock weapon downwardly.

19. The method of claim 16, wherein the step of providing the cartridge holder includes carrying the cartridge holder with a belt.

20. The method of claim 19, wherein the belt holds the cartridge holder so the slot faces upwardly.
